(19) United States
(12) Patent Application Publication
(10) Pub. No.: US 2006/0252636 A1
(43) Pub. Date: Nov. 9, 2006

(54) Silica supported ziegler-natta catalysts useful for preparing polyolefins

(75) Inventors: Kayo Vizzini, Pasadena, TX (US); Steven D. Gray, Houston, TX (US); Tim J. Coffy, Houston, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/122,920

(22) Filed: May 5, 2005

(51) Int. Cl. C08F 4/02; B01J 31/00

(52) U.S. Cl. 502/103; 502/115; 526/348; 526/351; 526/124.3

(57) ABSTRACT

A silica supported catalyst system can be prepared that includes the product of admixing a magnesium alkoxide with a group 4, 5, or 6 transition metal complex to form a magnesium transition metal alkoxide adduct having the general formula:
MgM(OR)₂(OR¹)ₚCl_{q}
wherein M is a group 4, 5, or 6 transition metal; R is an alkyl or aryl moiety; R¹ is a alkyl or aryl moiety having from 1 to 10 carbons, and p and q are 0 or an integer such that p+q equals the highest formal oxidation state of M; contacting the magnesium transition metal alkoxide adduct with a silica template to form a silica supported catalyst precursor; contacting the silica supported catalyst precursor chlorinating agent to form a chlorinated catalyst precursor; and contacting the chlorinated catalyst precursor with an aluminum alkyl to form a silica supported catalyst.

### BACKGROUND OF THE INVENTION

1. Technical Field

The invention relates to polyolefin catalysts, methods of making catalysts, and polymerization processes.

2. Background of the Art

Olefins, also called alkenes, are unsaturated hydrocarbons whose molecules contain one or more pairs of carbon atoms linked together by a double bond. When subjected to a polymerization process, olefins are converted to polyolefins, such as polyethylene and polypropylene. Ziegler-type polyolefin catalysts, their general methods of making, and subsequent use, are known in the polymerization art. While much is known about Ziegler-type catalysts, there is a constant search for improvements in their polymer yield, catalyst life, catalyst activity, amenability to use in large scale production processes, and in their ability to produce polyolefins having certain properties such as particle morphology.

Conventional Ziegler-Natta catalysts comprise a transition metal compound generally represented by the formula:
MRₓ
where M is a transition metal, R is a halogen or a hydrocarboxyl, and x is the valence of the transition metal. Typically, M is a group IVB metal such as titanium, chromium, or vanadium, and R is chlorine, bromine, or an alkoxy group. The transition metal compound is typically supported on an inert solid, e.g., magnesium chloride.

The properties of the polymerization catalyst may affect the properties of the polymer formed using the catalyst. For example, polymer morphology typically depends upon catalyst morphology. Acceptable polymer morphology differs for each class of production process (e.g., slurry loop, bimodal, gas phase, etc.), but typically includes uniformity of particle size and shape and an acceptable bulk density.

### SUMMARY OF THE INVENTION

In one aspect, the invention is a silica supported catalyst precursor that includes the product of admixing a magnesium alkoxide with a group 4, 5, or 6 transition metal complex to form a magnesium transition metal alkoxide adduct species having the general formula MgM(OR)₂(OR¹)ₚCl_{q} wherein M is a group 4, 5, or 6 transition metal; R is an alkyl or aryl moiety that may have from 1 to 20 carbons and include substituted alkyl radicals; R¹ is a alkyl or aryl moiety having from 1 to 10 carbons, and p+q are less than or equal to the highest formal oxidation state of M. The magnesium transition metal alkoxide adduct is contacted with a silica template to form a silica supported catalyst precursor.

In another aspect, the invention is a silica supported catalyst system including the product of admixing a magnesium alkoxide with a group 4, 5, or 6 transition metal complex to form a magnesium transition metal alkoxide adduct having the general formula: MgM(OR)₂(OR¹)ₚCl_{q}; wherein M is a group 4, 5, or 6 transition metal; R is an alkyl or aryl moiety that may have from 1 to 20 carbons and include substituted alkyl radicals; R¹ is a alkyl or aryl moiety having from 1 to 10 carbons, and p+q are less than or equal to the highest formal oxidation state of M. The magnesium transition metal alkoxide adduct is contacted with a silica template to form a silica supported catalyst precursor. The silica supported catalyst precursor is contacted with a chlorinating agent to form a chlorinated catalyst precursor. The chlorinated catalyst precursor is contacted with an aluminum alkyl to form a silica supported catalyst. The chlorinated catalyst precursor may be further contacted with an organo-aluminum cocatalyst component to form a catalysts system.

In still another aspect, the invention is a process for preparing a silica supported catalyst system including the product of admixing a magnesium alkoxide with a group 4, 5, or 6 transition metal complex to form a magnesium transition metal alkoxide adduct having the general formula: MgM(OR)₂(OR¹)ₚCl_{q}; wherein M is a group 4, 5, or 6 transition metal; R is an alkyl or aryl moiety that may have from 1 to 20 carbons and include substituted alkyl radicals; R¹ is a alkyl or aryl moiety having from 1 to 10 carbons, and p and q are 0 or an integer such that p+q are less than or equal to the highest formal oxidation state of M; and contacting the magnesium transition metal alkoxide adduct with a silica template to form a silica supported catalyst precursor.

Another aspect of the invention is a polymer fluff prepared using a silica supported catalyst system wherein the catalyst includes the product of admixing a magnesium alkoxide with a group 4, 5, or 6 transition metal complex to form a magnesium transition metal alkoxide adduct having the general formula: MgM(OR)₂(OR¹)ₚCl_{q}; wherein M is a group 4, 5, or 6 transition metal; R is an alkyl or aryl moiety that may have from 1 to 20 carbons and include substituted alkyl radicals; R¹ is a alkyl or aryl moiety having from 1 to 10 carbons, and p and q are 0 or an integer such that p+q are less than or equal to the highest formal oxidation state of M. The catalysts is further prepared when the magnesium transition metal alkoxide adduct is contacted with a silica template to form a silica supported catalyst precursor and the silica supported catalyst precursor is contacted with a chlorinating agent to form a chlorinated catalyst precursor and the chlorinated catalyst precursor is contacted with an organo-aluminum cocatalyst component. The polymer fluff is first formed into a pellet and then into an article of manufacture. The article of manufacture includes articles prepared using the polymer wherein the polymer is converted into a film and the article is a food wrapper; the polymer is converted by blow molding and the blown molded article is a milk bottle, bleach bottle or a toy part; or the polymer is converted into pipe.

### BRIEF DESCRIPTION OF THE FIGURES

For a detailed understanding and better appreciation of the invention, reference should be made to the following detailed description of the invention taken in conjunction with the accompanying drawings, wherein:

FIG. 1 is plot of the particle size distribution of P-10 and P-10-supported catalyst;

FIG. 2 is a plot of the particle size distribution of MS1733 and MS1733-supported catalyst.

FIG. 3 is a graph of the data from a polymerization lifetime study;

FIG. 4 is a photomicrograph of polymer prepared using the catalyst of Example 3;

FIG. 5 is a photomicrograph of polymer prepared using the catalyst of Example 2;

FIG. 6 is a photomicrograph of a polymer prepared using a typical powder non-controlled morphology ZN catalyst;

FIG. 7 is a graph of the hydrogen response of the catalyst of Example 2 as compared to the Comparative Ex 1 Catalyst; and

FIG. 8 is a graph of the GPC data for the silica-supported catalysts as compared to a Conventional Ziegler-Natta catalyst.

### DETAILED DESCRIPTION OF THE INVENTION

One commonly used polymerization process involves contacting an olefin monomer with a catalyst system that includes a conventional Ziegler-Natta catalyst, a co-catalyst, and one or more electron donors. Examples of such catalyst systems are provided in U.S. Pat. Nos. 4,107,413; 4,294,721; 4,439,540; 4,114,319; 4,220,554; 4,460,701; 4,562,173; and 5,066,738, which are incorporated herein by reference.

In an embodiment of the method of the invention, a magnesium alkoxide is admixed with a group 4, 5, or 6 transition metal complex to form a magnesium transition metal alkoxide adduct having the general formula:
MgM(OR)₂(OR¹)ₚCl_{q}
wherein M is a group 4, 5, or 6 transition metal; R is an alkyl or aryl moiety that may have from 1 to 20 carbons and include substituted alkyl radicals; R¹ is a alkyl or aryl moiety having from 1 to 10 carbons, and p and q are 0 or an integer such that p+q equal the highest formal oxidation state of M. The magnesium alkoxide may be prepared by any method known to be useful to those of ordinary skill to be useful in preparing such compounds. For example, a primary alcohol having at least 4 carbons may be reacted with a magnesium dialkyl. Exemplary magnesium dialkyls include diethyl magnesium, dipropyl magnesium, dibutyl magnesium, butylethylmagnesium, and the like. Exemplary primary alcohols include methyl 2-isopropanol, 2-ethylhexanol, cyclohexylmethanol, 4-methylcyclohexylmethanol and cyclohexylethanol, and diethylene glycol monoethyl ether.

In the method of the invention, the primary alcohols may have alkyl or aryl moieties that may 1 to 20 carbons and include, but are not limited to, substituted alkyl radicals such as —CF₃, —CCl₃, and the like; radicals including Si and silicon ethers such as —O—SiO₂; and aryl radicals such as a nitrobenzyl radical and an anisole radical.

Examples of transition metal complexes that may be employed include in the method of the invention include, but are not limited to, Ti, V, and, Cr-alkoxyl- and alkoxychloro-species such as VO(OⁱPr)₃, Ti(OBu)₄, VO(OⁱPr)₂Cl and Cr(OⁱPr)₃ In some embodiments, the magnesium-transition metal alkoxide adduct is soluble in non-coordinating hydrocarbon solvents such as toluene, heptane, and hexane. Non-soluble and partially soluble magnesium-transition metal alkoxide adducts may also be used with the process of the invention.

In one embodiment of the process of the invention, the preparation of the magnesium-transition metal alkoxide adducts may be done in the presence of a an organometallic agent such as an aluminum alkyl wherein the aluminum alkyl acts as a compatibilizer. For example, butylethyl magnesium and tetraethyl aluminum (TEAl) (make sure these are consistent) can be contacted with 2-ethyl-2-hexanol to form a compatibilized magnesium alkoxide which may then be reacted with Ti(OiPr)₃Cl to form a catalyst precursor.

Suitable organometallic agents include but are not limited to aluminum alkyls, aluminum alkyl hydrides, lithium aluminum alkyls, zinc alkyls, magnesium alkyls and the like. In one embodiment, the organometallic agent is TEAl. Contacting the precursor with the organometallic agents may reduce solution viscosity and may also reduce byproducts such as alcohols.

The magnesium transition metal alkoxide adduct species is contacted with a silica template to form a silica supported catalyst precursor. Silica supports useful in the invention, in one embodiment are vitreous silicas. These are non-crystalline, synthetic products and are often referred to as fused silicas (also called fumed silica, aerosils, pyrogenic silica). These are generally made by vapor-phase hydrolysis of silicon tetrahalides or silicon tetraalkoxides. Other methods for making fused silicas include vaporization of SiO₂, vaporization and oxidation of silicon, and high-temperature oxidation and hydrolysis of silicon compounds such as silicate esters. The preparation of such silicas is described, for example, in U.S. Pat. Nos. 4,243,422 and 4,098,595, the teachings of which are incorporated herein by reference. They may also be prepared using the methods of U.S. Pat. No. 5,232,883, also incorporated herein by reference wherein the templates can be prepared by spraying an electrostatically charged gellable liquid silica through a spraying orifice and into a chamber, so as to produce macrodrops which break up into microdrops which fall in the chamber and within which gelling is produced. NICE! Great job on the SiO2 description Gene!!!!

The silica templates that may be used in the invention are porous silica supports having a spherical or granular morphology. These templates have surface area of from about to about; a pore volume of from about 50 to about 1000 mL/g; an average pore diameter of from about 0.3 to about 5 Å; and an average D₅₀ diameter of from about 5 to about 250 microns. Exemplary silica templates include P10 from Fuji Silysia Chemical Ltd., and PQ MS1733 from PQ Corporation.

The surface of the silica support is reactive with the magnesium transition metal alkoxide adduct. The two components may be contacted in a slurry or any other method known to those of ordinary skill in the art of preparing supported catalysts. The application of the magnesium transition metal alkoxide adduct to the silica support may performed at temperatures ranging from about −40 to about 200° C. In another embodiment, the application is performed at from about 0 to about 100° C. and in still another embodiment, at from about 20 to about 35° C.

The supported catalyst precursor is next halogenated to form a halogenated supported catalyst. It may also be titanated and halogenated. Agents useful for halogenating the silica supported catalyst include any halogenating agent which, when utilized in the invention, will yield a suitable catalyst. Some of the halogenating agents may also serve as titanating agents useful for incorporating titanium into the supported catalyst. For example, TiCl₄ may both titanate and halogenate a catalyst precursor.

Metal chlorides may be desirable halogenating agents and/or titanating/halogenating agents. Non-limiting examples of suitable halogenating and/or titanating/halogenating agents include Group III, Group IV and Group V halides, hydrogen halides, or the halogens themselves. Specific examples of halogenating and/or titanating/halogenating agents are BCl₃, AlCl₃, CCl₄, SiCl₄, TiCl₄, ZrCl₄, VOCl₄, VOCl₂, CrOCl₂, SbCl₅, POCl₂, PCl₅, HfCl₄, and Ti(OR¹)ₙCl₄₋ₙ, wherein R¹ is an alkyl having 1 to 8 carbon atoms, and n is from 0 to 4. Mixtures of any of two or more of the foregoing may also be used as halogenating and/or titanating/halogenating agents. Other halogenating and/or titanating/halogenating agents include alkyl halides such as PhCH₂Cl and PhCOCl and alkylhalosilanes of the formula R′ₙSiX₍₄₋ₙ₎, wherein X is a halogen, R′ is a substituted or unsubstituted hydrocarbyl having 1 to 20 carbon atoms, and n is 1-3

Possible halogenating and/or titanating/halogenating agents are SiCl₄, TiCl₄, TiClₙ(OR)₄₋ₙ, and mixtures of any of two or more of the foregoing. One embodiment employs as the halogenating agent a mixture of TiCl₄, and Ti(OR)₄, wherein R is a butyl group. In another embodiment, R is a propyl group. The molar ratio of TiCl₄ to Ti(OR)ₙ is generally in the range of about 4 to about 0.1, may be in the range of about 3 to about 1, and may be in the narrower range of about 2 to about 1.

In the practice of the invention, there is generally at least one halogenation step, and there may be two or more. A non-limiting example of a suitable halogenation treatment includes a first halogenation treatment with a mixture of TiCl₄ and Ti(OBu)₄, followed by a second halogenation treatment with TiCl₄. Halogenation and titanation of catalysts and catalyst precursors is disclosed in U.S. Pat. No. 6,693,058 to Coffy, et al., the contents of which are incorporated herein by reference.

The halogenation and titanation of the catalyst precursor may be carried out under conditions suitable to yield the desired catalyst component. Suitable temperatures for halogenating and titanating are generally in the range of about −20° C. to about 100° C., may be in the range of about 0° C. to about 75° C. and may be in the narrower range of about 25° C. to about 65° C.

In the practice of the invention, halogenation may be conducted at a molar ratio of halogenating agent to catalyst in the range of about 1 to about 20, may be in the range of about 1 to about 10, and may be in the narrower range of about 1 to about 8.

The catalyst made by the above described process may be further combined with an organo-aluminum cocatalyst component to generate a catalyst system suitable for the polymerization of olefins. Typically, the cocatalysts which are used together with the transition metal containing catalyst are organometallic compounds of Group Ia, IIa, and IIIa metals such as aluminum alkyls, zinc alkyls, magnesium alkyls and the like. Organometallic compounds that may be employed in the practice of the invention are trialkylaluminum compounds. In one embodiment, the cocatalyst component is TEAl.

An internal electron donor for treating the supported catalyst or catalyst precursor may be used. The internal electron donor may be added during or after the halogenation step. Internal electron donors for use in the preparation of polyolefin catalysts are known, and any suitable internal electron donor may be utilized in the invention that will provide a suitable catalyst. Internal electron donors, also known as Lewis bases, are organic compounds of oxygen, nitrogen, phosphorous, or sulfur which are capable of donating an electron pair to the catalyst. The internal electron donor may be a monofunctional or polyfunctional compound, and may be selected from among the aliphatic or aromatic carboxylic acids and their alkyl esters, the aliphatic or cyclic ethers, ketones, vinyl esters, acryl derivatives, particularly alkyl acrylates or methacrylates and silanes. The amount of internal electron donor utilized may vary over a broad range and is generally in the range of about 0.01 to about 2 equivalents, but may be in the range of about 0.05 to about 0.5 equivalents. The catalyst precursor may be contacted with the internal electron donor for a contacting period in the range of about 0.5 hours to about 4 hours. In one embodiment a range of about 1 hour to about 2 hours is employed.

External electron donors that may be added at the end of the preparation or utilized with the use of catalyst during polymerization and include those known in the art, including, but not limited to alkoxysilanes.

The process of the invention the invention may be performed in a solvent. The process may be performed in any suitable solvent or reaction medium. Non-limiting examples of suitable solvents or reaction media include toluene, heptane, hexane, octane and the like. A mixture of solvents may also be used.

The catalysts (including catalyst precursors, catalysts and catalysts systems) described herein may be used for the polymerization of olefins, including a-olefins. For example, the present catalyst is useful for catalyzing ethylene, propylene, butylene, pentene, hexene, 4-methylpentene and other alkenes having at least 2 carbon atoms, and also for mixtures thereof. These catalysts may be utilized for the polymerization of ethylene to produce polyethylene, such as polyethylene with controlled powder morphology. Olefin polymerization methods are well known in general, and any suitable method may be utilized. The catalyst systems of the invention may offer improvements in one or more of the following properties: morphology control, fines reduction, and hydrogen response.

The control of fines is important in the production of polymers, especially when the production unit utilized a settling process such as a loop reactor having settling legs. In polymerization units utilizing settling legs, a reduction of fines can increase throughput and product quality wherein the polymer fluff prepared therein in less expensive to produce and is more easily handled downstream in the production unit. Polymer fluff prepared in a production unit utilizing the catalysts systems of the invention can have a reduction in fines without loss of quality or throughput in comparison to conventional ZN catalysts systems.

In one embodiment, the polymers of the invention are converted into a film and the film used in food packaging. In another embodiment, the polymer is converted by blow molding and the molded article is a milk bottle, bleach bottle or toy part. In still another embodiment, the polymer is formed into pipe and the pipe is a PE-100 pressure-rated pipe.

The following non-limiting examples and comparative example are provided merely to illustrate the invention, and are not meant to limit the scope of the claims.

### EXAMPLES

General Overview

Silica supported catalysts systems are prepared using two silica templates: CARiACT™ P-10, manufactured by Fuji Silysia Chemical Ltd., and PQ's Corporation's MS1773. The silica templates have the physical properties displayed below in Table A. The P10 template is spherical or microspheroidal and the MS 1733 is granular. The catalyst systems are tested as shown in the enumerated examples. For convenience, the Reagent ratios for the Examples are listed below in Table B.

Unless otherwise stated, all experiments are conducted under inert atmosphere. Neat 2-Ethylhexanol, Titanium(IV)chloride (TiCl4), and Vanadium(V)oxotrichloride (VOCl₃) are purchased form Aldrich and used as received. Chlorotitaniumtrisisopropoxide is purchased as a 1.0 M solution in hexanes from Aldrich and used as received. Heptane solutions of butylethyl magnesium (BEM, 15.6 weight percent) and Triethyl aluminum (25 weight percent) are purchased from Akzo Nobel and used without further purification. P10 silica is purchased from Fuji Silysia Chemical and dried under a nitrogen flow at 160° C. overnight. MS1733 silica is purchased from the PQ Cooperation and dried under dynamic vacuum at 160° C. for eight hours prior to use. Mg(O-2-ethylhexyl)₂ is prepared in situ from the reaction of BEM and 2-ethylhexanol and reacted with ClTi(OⁱPr)₃ in hexane solvent to afford the Mg(OR)₂Ti(OR¹)₃Cl adduct complex employed in some of the examples.

TABLE A
Physical Properties of Silica Templates

| | Surface | | | | | |
|---|---|---|---|---|---|---|
| | Area | Pore | Ave. Pore | D₅₀ | Si—OH | Si—OH |
| | (m²/g) | Volume(mL/g) | Diameter(Å) | (micron) | (unit/nm²) | (mmol/g) |
| P10 | 281 | 1.65 | 185 | 20 | 5.2 | 0.612-1.94 |
| MS1733 | 320 | 1.90 | 238 | 86 | N/A | N/A |

TABLE B
Reagent Ratios Employed in Catalyst Preparations

| | | Mg-to Silica Ratio | | |
|---|---|---|---|---|
| | Silica | (mol Mg/g silica) | TiCl₄ | TEAI |
| Example 1 | P10 | 0.90 | 4.0 | 0.16 |
| Example 2 | P10 | 5.00 | 20 | 0.36 |
| Example 3 | MS1733 | 1.25 | 20 | 0.36 |
| Example 4 | MS1733 | 2.50 | 20 | 0.36 |
| Example 5 | MS1733 | 5.00 | 20 | 0.36 |

### Example 1

A 100 mL Schlenk flask is charged with BEM (1.6 mmol), TEAl (0.143 mmol), and hexane (50 mL). With rapid stirring, a solution of 2-ethylhexanol (3.68 mmol) in hexane (10 mL) is added dropwise to the flask. The mixture is stirred for 1 hour. A solution of ClTi(OⁱPr)₃ (1.6 mmol) in hexanes (10 mL) is added to the reaction mixture. After 1 hour, this solution is then transferred to the Schlenk flask containing 2.0 g of silica. The slurry is stirred for 1 hour. Agitation is discontinued and the solid is allowed to settle. The supernatant is decanted and the solid is washed with hexane (3×50 mL). The solid is resuspended in hexane (80 mL) and TiCl₄ (6.4 mmol) is added dropwise. After the addition is complete, the slurry is mixed for an additional 1.5 hours. After this time, the solid is allowed to settle and the supernatant is decanted. The resultant yellow solid is washed (3×50 mL hexane) and resuspended in hexane (100 mL). A solution of TEAl (0.25 mmol) is added dropwise to the slurry. The mixture is agitated for 1 hour. The supernatant is decanted and the resultant brown solid is washed with hexane (50 mL) and dried under vacuum to afford the catalyst of Example 1.

### Examples 2-5

A 500 mL round bottom flask is charged heptane solutions of BEM (0.100 mol) and TEAl (0.015 mol). Additional hexane (50 mL) is added to the flask. A solution of 2-ethylhexanol (0.203 mol) in hexane (20 mL) is added dropwise to flask. The mixture is stirred for 1 hour. A hexane solution of ClTi(OⁱPr)₃ (0.10 mol) is then added and the mixture is stirred for 1 hour. The solution is diluted to a total volume of 400 mL with hexane and portions of this mixture (25 to 100 mL) based on the targeted adduct-to-silica ratio are transferred to pressure-rated bottle bottles containing 5.0 g of silica. The resultant slurries are stirred for 1 hour. The solids are allowed to settle and the supernatant is decanted. The solids are washed with hexane (4×100 mL). The washed solids are reslurried in hexane (80 mL) and TiCl₄ (0.10 mol) is added dropwise. The slurry is mixed for 1 hour and agitation is discontinued. The supernatant is decanted and the yellow solid is washed with hexane (4×100 mL). The resultant solids are resuspended in hexane (100 mL) and TEAl (1.82 mmol) is added. The slurry is stirred for an additional hour. Agitation was discontinued and the solids are allowed to settle. The supernatant is decanted and the resultant brown solids are washed with hexane (100 mL) and dried under vacuum.

### Comparative Example 1

equivalent of Mg(OEt)₂ is refluxed with 2.5 equivalents of TiCl₄ in an heptane solvent at about 117° C. for 4 hours. The resultant solids are washed at 75° C. in heptane and then heated at 120° C. for 18 hours. The solids are preactivated with TEAl to produce a conventional Ziegler-Natta catalyst system.

Testing

The catalysts, catalyst system and polymers produced therewith are tested as set forth in the following tables, discussion of the examples, and figures. The testing methodology includes:
Catalyst activity is determined by mass balance;
Polymer bulk density is determined using ASTM D1895-69;
Polymer D₅₀ is determined using ASTM B822;
Polymer fines are determined by tumbling a representative sample of each polymer made for about 20 minutes. A polymer sample of about 50 g is removed, weighed and screened for 10 minutes using a CSC Scientific Sieve Shaker and the amount of polymer fines of less than 125 micrometer size is determined by weighing and from the values are calculated the weight percent fines of less than 125 micrometer size for each polymer so tested;
Extracted Wax is determined by extraction with cyclohexane for three hours using Soxtec® Avanti Auto-extraction unit
Melt Index, MI₅, is determined according to ASTM D-1238 at 190° C. using a 21.6 kg weight; MI5 is 5.0 kg.
High Load Melt Index, (HLMI) is determined according to ASTM D-1238 at 190° C. using a 21,600 g weight;
Gel Permeation Chromatography (GPC) data is determined using narrow polystyrene standards. The calibration is checked using a broad polyethylene standard having an Mn of 17,000, Mw of 180,000, and an Mz of 1,8000,000.; and

Photomicrographs are taken using a NIKON® OPT: photo 2-POL microscope with camera and magnification of 20×.

Polymerization Testing

Ethylene polymerization studies were performed in a 4 L Autoclave Engineer system fitted with four mixing baffles and two opposed pitch propellers. Hexane (2 L) was employed as the diluent. The reaction temperature was controlled at 80° C. via an external jacket using mixtures of steam and cold water. Ethylene and hydrogen were introduced to the reactor vessel via Brooks mass flow controllers. A dome loaded back-pressure regulator was employed to maintain the target pressure (125 psig). For standard runs, an ethylene flow rate of 8.0 L/min was employed. The hydrogen flow was varied to meet the target H₂/C₂ ratio of the run (0.25 molar ratio for standard conditions). TEAl and TIBAI (0.25 to 1.0 mmol/L relative to the hexane diluent) were employed as a cocatalyst for the screening studies.

TABLE 1
Activity and Bulk Polymer Properties

| | | Mg-to-Silica | |
|---|---|---|---|
| | | Ratio | Activity (kg |
| Catalyst | Support | (mol Mg/g silica) | PE/g/h) |
| Example 1 | P10 | 0.90 | 1.83 |
| Example 2 | P10 | 5.00 | 3.50 |
| Example 3 | MS1733 | 1.25 | 2.45 |
| Example 4 | MS1733 | 2.50 | 1.70 |
| Example 5 | MS1733 | 5.00 | 1.75 |
| Comp. Ex. 1 | MgCl₂ | — | 28.6 |

TABLE 2
Bulk Properties Polymers Derived From Example Catalysts

| | Polymer | Polymer | Polymer | |
|---|---|---|---|---|
| Catalyst | Bulk Den. | D₅₀ | Fines | Extracted Wax |
| System | (g/cc) | (micron) | (percent) | (percent) |
| Example 1 | 0.32 | 315 | 1.8 | 1.3 |
| Example 2 | 0.32 | 393 | 0.2 | 0.3 |
| Example 3 | 0.24 | 470 | 1.4 | 0.2 |
| Example 4 | 0.17 | 591 | 1.0 | <0.1 |
| Example 5 | 0.17 | 781 | 0.2 | <0.1 |
| Comp. Ex 1 | 0.29 | 205 | 1.8 | 0.5 |

TABLE 3
Properties of Polymers Produced With Silica-Supported Systems

| Catalyst | MI₅ | HLMI | SR₅ |
|---|---|---|---|
| System | (dg/min) | (dg/min) | (HLMI/MI₅) |
| Example 1 | 0.60 | 9.2 | 15.3 |
| Example 2 | 0.91 | 16.5 | 18.1 |
| Example 3 | 0.23 | 3.5 | 15.2 |
| Example 4 | 0.30 | 4.2 | 14.0 |
| Example 5 | 0.33 | 4.0 | 12.1 |
| Comp. Ex. 1 | 0.99 | 11.6 | 11.7 |

TABLE 4
Molecular Weight Data by Gel Permeation Chromatography

| | Mn | Mw | Mz | Mp | D |
|---|---|---|---|---|---|
| Example 1 | 26,457 | 209,752 | 1,419,991 | 59,858 | 7.93 |
| Example 2 | 20,875 | 160,397 | 1,126,558 | 45,672 | 7.68 |
| Example 3 | 26,089 | 248,239 | 1,905,814 | 66,944 | 9.52 |
| Example 4 | 28,165 | 257,316 | 1,825,316 | 70,708 | 9.14 |
| Example 5 | 30,497 | 289,967 | 2,704,768 | 71,319 | 9.50 |
| Comp. Ex. 1 | 29,680 | 201,865 | 1,064,535 | 72,273 | 6.80 |

### DISCUSSION OF THE EXAMPLES

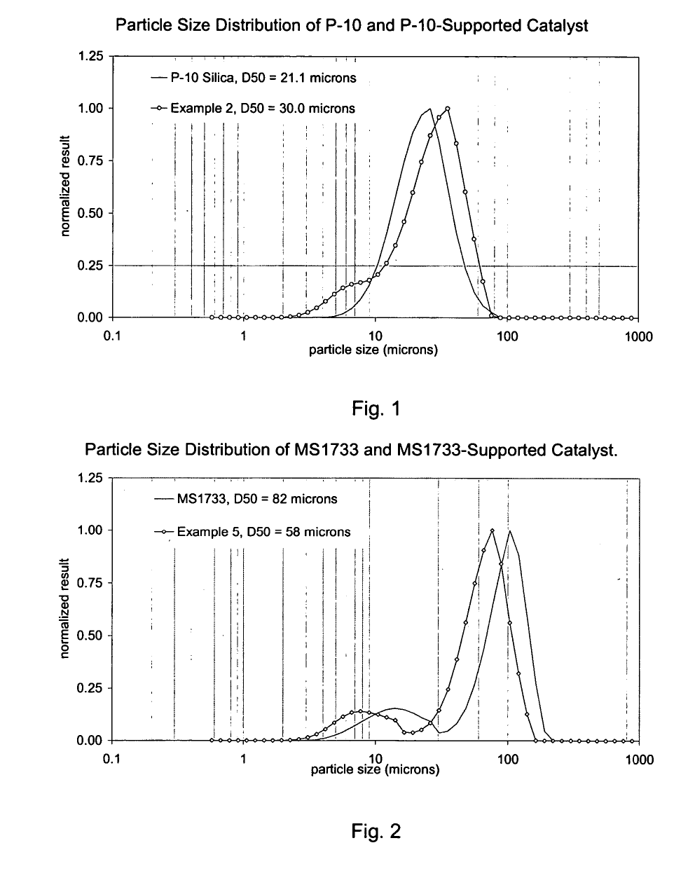

FIGS. 1 and 2 compare particle size data for the catalysts of the invention and the silica template. It can be seen that, for example, Example 2 has a broad distribution and average particle size (D₅₀) that mirrors the P10 support template. The MS1733 template catalyst of Example 5 displays a bimodal distribution with D₅₀ of ca. 80 microns. Like the P10 system, the MS1733 templated catalyst has a distribution similar to the silica template, but shifted to lower values suggesting degradation of the silica support at some point in the reaction manifold.

Bench polymerization screening data in Table 1 shows that activities ranged from 1.7 to 3.5 kg PE/g catalyst/h. The effects of the silica support on the polymerization behavior can be determined by comparing Example 2 and Example 5. Here, the smaller pore volume P10-derived catalyst of Example 2 shows a higher activity than that made with the MS1733 template in Example 5. The effects of reagent ratios on activity show that higher Mg—Ti-alkoxide loadings increase catalyst life in the P10 system, but this trend is not apparent in the catalysts prepared using the MS1733 template.

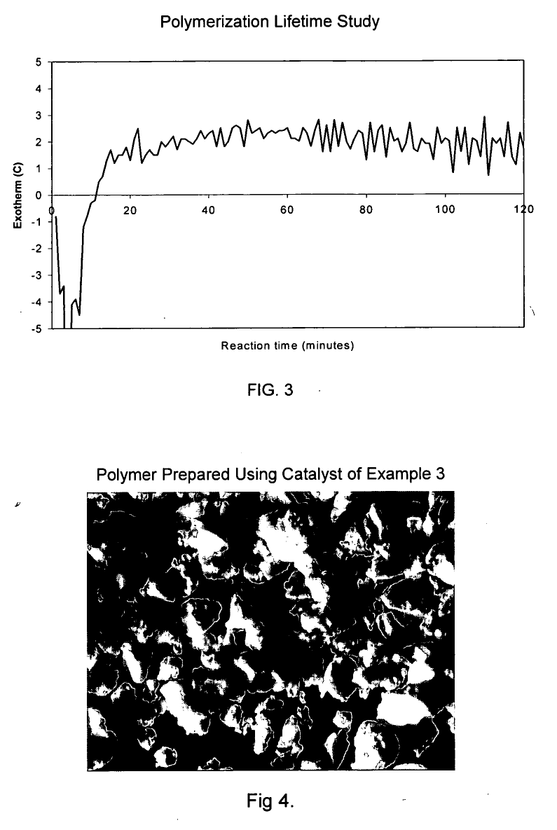

Since the silica-supported catalysts showed lower activity than the activities typical of conventional Ziegler-Natta systems, the catalysts were tested to determine whether they would be likely to die out in bimodal reactor configurations as well as to determine whether there might be high levels of residues caused by the residual silica in the product. Therefore, to gauge the suitability of these systems for commercial production, the catalyst of Example 2 was subjected to a patent life study. FIG. 3 shows the polymerization exotherm (reactor—cooling water temperature) over time. Here, the silica-templated catalyst retains greater than 90% of its activity for up to two hours under standard conditions. Therefore, the silica supported catalyst lifetime should be compatible with long residence times such as those seen in bimodal process.

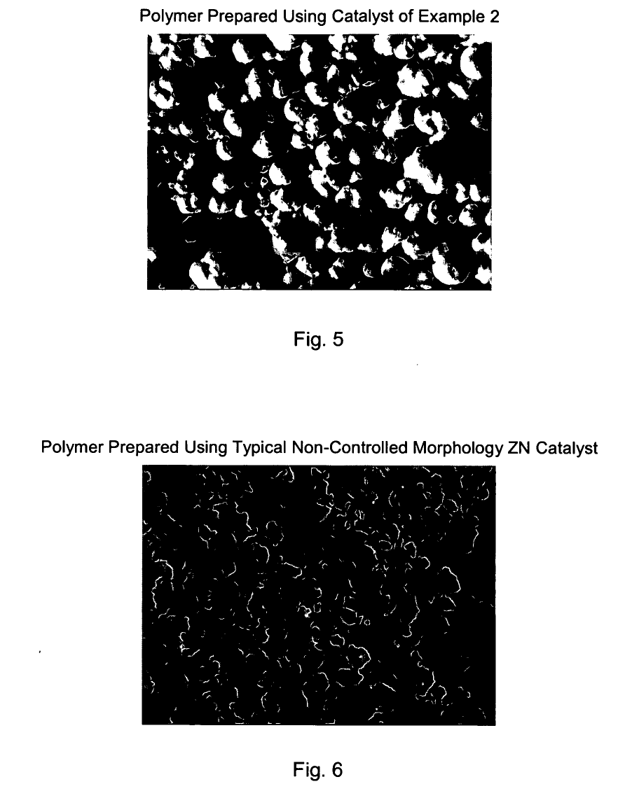

Bulk properties of polymers made by the catalysts of this invention are displayed in Table 2. For comparison, powder data provided by conventional MgCl₂-supported Ziegler-Natta systems is also included. Within the examples of the invention, differences in the powder bulk densities can be seen as a function of the silica template. Some of these differences can be explained by the powder structures shown in FIG. 4 and FIG. 5. The MS1733-supported powder provided by Example 3 gave irregular, fractured particles, FIG. 4. Conversely, the polymer given from Example 2 yielded uniform powder with a spherical morphology, FIG. 5. Powders like those provided by the catalyst of Example 2 are quite favorable towards large-scale production where small particles and polymer fines offer production challenges. The improvement of the powder morphology given by Example 2 over prior art is readily seen by comparing FIG. 5 to the non-uniform, non-spherical powders provided by a typical Ziegler-Natta catalyst (Comp. Ex 1) under similar reaction conditions, FIG. 6.

Polymer melt flow data is displayed in Table 3. Shear thinning properties as gauged by melt flow ratios (the “SR2, SR5” or HLMI/MI2MI5) show enhanced shear thinning polymers are produced with the invention when compared to those produced using the conventional catalyst (Comp. Ex 1). Also surprising is the role that the silica template appears to play in the catalysts hydrogen response. This is seen by comparing polymers from Examples 1 and 2 to those of Example 3-5. Here the shift in polymer melt flows seen under similar reactor conditions suggests the nature of the silica template plays a role in the hydrogen response of the catalyst. In these particular examples, P10 support-templates appear to provide more hydrogen sensitive catalysts than the large pore volume MS 1733 silica.

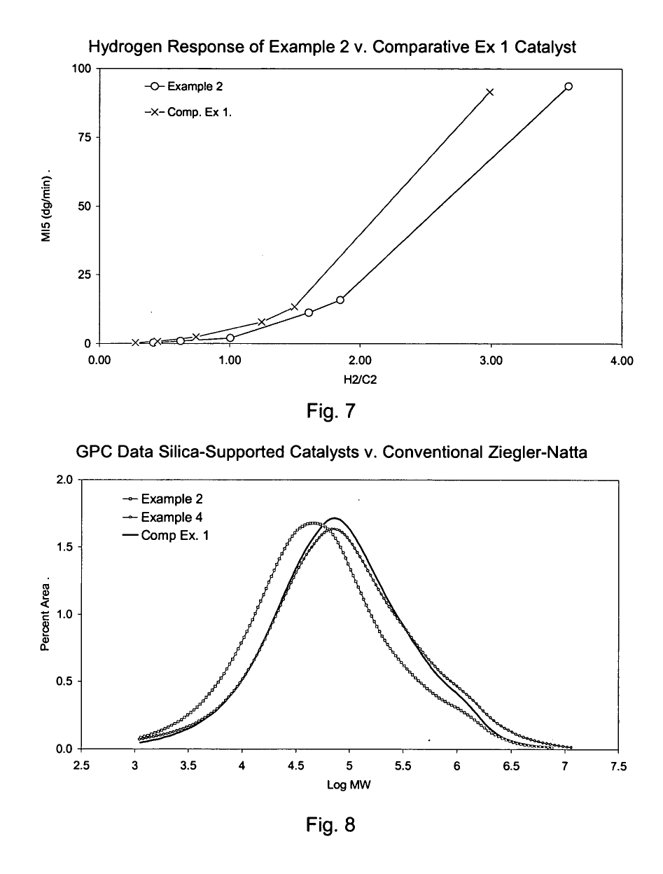

Polymer melt flows at various hydrogen-to-ethylene ratios are compared for Example 2 and the MgCl₂-supported Ziegler-Natta system of Comparative Example 1 in FIG. 7. Despite the enhanced polymer shear behavior seen by the melt flow ratios, the silica supported catalyst of Example 2 shows only a modestly decreased sensitivity towards hydrogen. A catalyst system that affords highly-shear thinning materials yet still responds to hydrogen may provide an economic advantage in commercial production operations. For example, the melt flows of Cr-based polymers are not greatly affected by hydrogen which limits their potential use in applications requiring lower densities and/or higher melt flows, for example medium molecular weight, medium-density film grade polyethylenes.

Table 4 and FIG. 8 display the molecular weight distribution data by GPC for catalysts prepared in the examples. The silica-templated catalysts of the invention afford broader molecular weight distribution polymers as compared to the conventional Ziegler-Natta system of Comparative Example 1. This can, in part, contribute to the enhanced shear behavior of the polymers generated from the silica-templated systems.

What is claimed is:

1. A silica supported catalyst precursor comprising the product of admixing a magnesium alkoxide with a group 4, 5, or 6 transition metal complex to form a magnesium transition metal alkoxide adduct having the general formula:
MgM(OR)₂(OR¹)ₚCl_{q}
wherein M is a group 4, 5, or 6 transition metal; R is an alkyl or aryl moiety that may have from 1 to 20 carbons and include substituted alkyl radicals; R¹ is a alkyl or aryl moiety having from 1 to 10 carbons, and p and q are 0 or an integer such that p+q are less than or equal to the highest formal oxidation state of M; and contacting the magnesium transition metal alkoxide adduct with a silica template to form a silica supported catalyst precursor.

2. A silica supported catalyst system comprising the product of admixing a magnesium alkoxide with a group 4, 5, or 6 transition metal complex to form a magnesium transition metal alkoxide adduct having the general formula:
MgM(OR)₂(OR¹)ₚCl_{q}
wherein M is a group 4, 5, or 6 transition metal; R is an alkyl or aryl moiety that may have from 1 to 20 carbons and include substituted alkyl radicals; R¹ is a alkyl or aryl moiety having from 1 to 10 carbons, and p and q are 0 or an integer such that p+q=the highest formal oxidation state of M;
contacting the magnesium transition metal alkoxide adduct with a silica template to form a silica supported catalyst precursor;
contacting the silica supported catalyst precursor chlorinating agent to form a chlorinated catalyst precursor; and
contacting the chlorinated catalyst precursor with an aluminum alkyl to form a silica supported catalyst.

3. A process for preparing a silica supported catalyst system comprising the product of admixing a magnesium alkoxide with a group 4, 5, or 6 transition metal complex to form a magnesium transition metal alkoxide adduct having the general formula:
MgM(OR)₂(OR¹)ₚCl_{q}
wherein M is a group 4, 5, or 6 transition metal; R is an alkyl or aryl moiety that may have from 1 to 20 carbons and include substituted alkyl radicals; R¹ is a alkyl or aryl moiety having from 1 to 10 carbons, and p and q are 0 or an integer such that p+q=the highest formal oxidation state of M; and
contacting the magnesium transition metal alkoxide adduct with a silica template to form a silica supported catalyst precursor.

4. The process of claim 3 further comprising contacting the silica supported catalyst precursor with a first chlorinating agent to form a chlorinated catalyst precursor.

5. The process of claim 4 further comprising contacting the chlorinated catalyst precursor with an organo-aluminum cocatalyst component to form silica supported catalyst system.

6. The process of claim 3 wherein the magnesium transition metal alkoxide adduct if formed in the presence of an organometallic agent.

7. The process of claim 6 wherein the metal alkyl is TEAl.

8. The process of claim 3 wherein the contacting the magnesium transition metal alkoxide adduct with a silica template is performed at from about −40 to about 200° C.

9. The process of claim 8 wherein the contacting the magnesium transition metal alkoxide adduct with a silica template is performed at from about 20 to about 35° C.

10. The process of claim 4 wherein the chlorinating agent is selected from the group consisting of BCl₃, AlCl₃, CCl₄, SiCl₄, TiCl₄, ZrCl₄, VOCl₄, VOCl₂, CrOCl₂, SbCl₅, POCl₂, PCl₅, HfCl₄, Ti(OR²)ₙCl₄₋ₙ, and mixtures thereof, wherein R² is an alkyl having 1 to 8 carbon atoms, and n is from 0 to 4.

11. The process of claim 10 wherein the chlorinating agent is TiCl₄.

12. The process of claim 4 further comprising a second chlorination using a second chlorination agent wherein the first chlorination agent is a mixture of TiCl4 and Ti(OR)₄, and the second chlorination agent is TiCl₄.

13. The process of claim 5 wherein the organo-aluminum cocatalyst component is TEAl

14. The process of claim 5 further comprising incorporating an external electron donor with the catalyst system.

15. The process of claim 5 further comprising incorporating an internal electron donor with the catalyst system.

16. The process of claim 5 wherein the process is performed in a solvent.

17. The process of claim 16 wherein the solvent is selected from the group consisting of toluene, heptane, hexane, octane, and mixtures thereof.

18. A polymer fluff having very low levels of fines prepared using a catalyst system of claim 3.

19. The polymer fluff of claim 18 wherein the polymer fluff is first formed into a pellet and then formed into an article of manufacture comprising a polymer prepared from the polymer fluff of claim 18 wherein the polymer is converted into a film and the article is a food wrapper; the polymer is converted by blow molding and the blown molded article is a milk bottle, bleach bottle or a toy part; or the polymer is converted into pipe.

20. The polymer fluff of claim 18 wherein the polymer is selected from the group consisting of polyethylene, polypropylene, and copolymers of ethylene and propylene.
